(19) United States
(12) Patent Application Publication
(10) Pub. No.: US 2006/0219259 A1
(43) Pub. Date: Oct. 5, 2006

(54) Method of cleaning a semiconductor wafer

(75) Inventors: Hoon Jung Oh, Icheon-shi (KR); Woo Jin Kim, Icheon-shi (KR); Baik Il Choi, Seoul (KR); Hyo Geun Yoon, Icheon-shi (KR); Hyo Seob Yoon, Icheon-shi (KR); Pyeong Won Oh, Icheon-shi (KR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: HYNIX SEMICONDUCTOR INC., Icheon-shi (KR)

(21) Appl. No.: 11/288,481

(22) Filed: Nov. 29, 2005

(30) Foreign Application Priority Data
Apr. 4, 2005 (KR) 2005-28294

(51) Int. Cl. C23G 1/00; B08B 3/00

(52) U.S. Cl. 134/2; 134/26

(57) ABSTRACT

A method of cleaning a semiconductor wafer, including the steps of supplying a mixed solution of a dilute hydrofluoric acid solution and hydrogen peroxide solution to a bath; loading the semiconductor wafer into the bath such that the semiconductor wafer is dipped into the mixed solution, and rinsing the semiconductor wafer with the mixed solution; draining the mixed solution and supplying deionized water to the bath, and rinsing the semiconductor wafer with the deionized water; and draining the deionized water and supplying isopropyl alcohol to the bath, and drying the semiconductor wafer with isopropyl alcohol.

### BACKGROUND OF THE INVENTION

1. Field of the Invention

The invention relates to a method of cleaning a semiconductor wafer, and more particularly to a method of cleaning a semiconductor wafer capable of inhibiting metal contamination.

2. Description of the Related Art

Increased integration in semiconductor memory devices such as DRAMs (dynamic random access memories) and demand for high performance thereof has required the steady replacement of conventional materials constituting parts of semiconductors with novel materials. For example, various attempts to form gate-insulating layers or dielectric layers are being actively undertaken using materials having a high dielectric constant, for example metal oxides, instead of using a silicon dioxide (SiO₂) layer or silicon nitride (Si₃N₄) layer such as employed as gate-insulating layers of transistors constituting DRAMs or dielectric layers of capacitors. Among these metal oxides, alumina (Al₂O₃) is representative. In addition, in order to increase the operating speed of DRAM devices, a capacitor having a metal-insulator-metal (MIM) structure is employed.

Generally, an amorphous alumina (Al₂O₃) layer is formed by metal organic chemical vapor deposition (MOCVD), or atomic layer deposition (ALD) using metal/organic sources. However, an amorphous alumina (Al₂O₃) layer is susceptible to etching by a variety of chemicals used in DRAM manufacturing processes. In particular, upon performing a cleaning process involving batch dipping wherein several wafer sheets are dipped in a bath containing such chemicals, aluminum elements may be separated from the alumina (Al₂O₃) film, thereby forming particles. Thereby, when other wafers are cleaned in the same bath, these wafers may be contaminated with aluminum (Al) particles generated from previous cleaning steps. As such, wafers must be cleaned by means of a separate facility.

Similarly, such problems are also raised in cleaning processes performed after formation of the capacitor having the metal-insulator-metal (MIM) structure. That is, when cleaning processes are carried out after formation of a metal-insulator-metal (MIM) type capacitor, an exposed metal layer in the bath leads to chemical degradation by the particles. As a result, the wafer may be contaminated with such particles. In addition, the cleaning facility used in the cleaning processes after formation of the MIM type capacitor, cannot be used in cleaning of other wafers, which in turn leads to problems associated with a need for additional facilities.

### GENERAL DESCRIPTION OF THE INVENTION

The invention provides a method of cleaning a semiconductor wafer by eliminating the occurrence of metal or metal oxide particles so as not to cause metal contamination.

In accordance with an aspect of the invention, a method of cleaning a semiconductor wafer includes the step of:

supplying a mixed solution of a dilute hydrofluoric acid solution and a hydrogen peroxide solution to a bath;

loading a semiconductor wafer into the bath such that the semiconductor wafer is dipped into the mixed solution, rinsing the semiconductor wafer with the mixed solution;

draining the mixed solution and supplying deionized water to the bath, rinsing the semiconductor wafer with the deionized water; and

draining the deionized water and supplying isopropyl alcohol to the bath, drying the semiconductor wafer.

The semiconductor wafer may be loaded to the bath in a batch form of a set including a plurality of wafers.

In accordance with another aspect of the invention, a method of cleaning a semiconductor wafer includes the steps of: finally rinsing a semiconductor wafer having an exposed metal-containing layer with a mixed solution of a dilute hydrofluoric acid solution and hydrogen peroxide solution.

The above-mentioned method may further include rinsing the finally rinsed semiconductor wafer with deionized water.

In this case, the method may further include drying the semiconductor wafer rinsed with deionized water. Drying may be carried out using isopropyl alcohol.

Preferably, in the case of either aspect of the invention the concentration of the hydrofluoric acid is in the range of 44 wt % to 53 wt %, preferably 49 wt %, and the concentration of hydrogen peroxide is in the range of 25 wt % to 35 wt %, preferably 30 wt %.

Preferably, in either case the volume ratio of hydrofluoric acid to deionized water to hydrogen peroxide contained in the mixed solution is in the range of 1 to 100-300 to 0.05-0.1, respectively.

Preferably, in either case the temperature of the mixed solution is in the range of 20° C. to 30° C.

The metal-containing layer may include a metal layer or a metal oxide layer.

The metal layer may include a titanium film, a copper film, a platinum film or a ruthenium film, for example. The metal oxide layer may include alumina, a hafnium oxide layer, a zirconium oxide layer, a tantalum oxide layer, or a titanium dioxide layer, for example.

### BRIEF DESCRIPTION OF THE DRAWINGS

The invention will be more clearly understood from the following detailed description taken in conjunction with the accompanying drawings, in which:

FIGS. 1 through 7 show sequential processes illustrating a method of cleaning a semiconductor wafer in accordance with the invention;

FIG. 8 is a graph showing the degree of copper contamination with respect to the content of hydrogen peroxide in a cleaning solution employed in a method of cleaning a semiconductor wafer in accordance with the invention; and

FIG. 9 is a graph showing the degree of metal contamination with respect to the volume ratio of hydrogen peroxide in a cleaning solution employed in a method of cleaning a semiconductor wafer in accordance with the invention.

### DESCRIPTION OF THE PREFERRED EMBODIMENTS

The invention will now be described more fully hereinafter with reference to accompanying drawings, in which preferred embodiments of the invention are shown. The invention may, however, be embodied in various different forms and should not be construed as limited to the embodiments set forth herein.

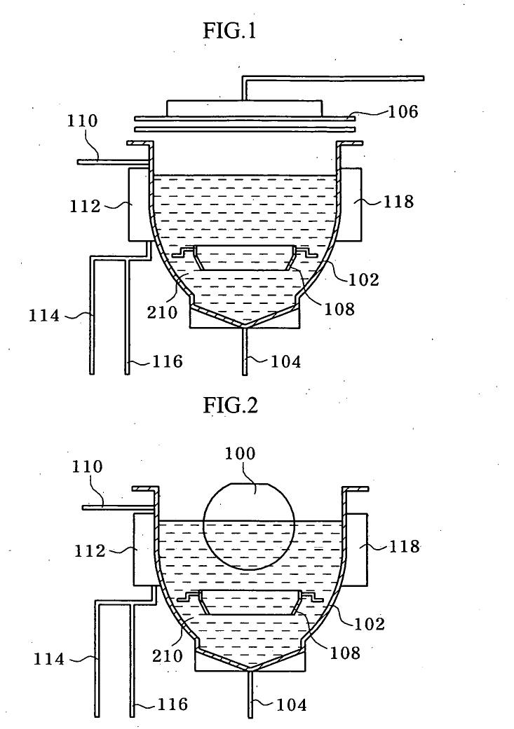

FIGS. 1 through 7 show sequential processes illustrating a method of cleaning a semiconductor wafer in accordance with the invention. In the drawings, like numbers refer to similar elements throughout the specification.

Referring to FIG. 1, a mixed solution of a dilute hydrofluoric acid (HF) solution and a hydrogen peroxide (H₂O₂) solution are supplied to a bath 102. The bath 102 is a vessel capable of containing a predetermined volume of liquid, and is provided with a drain line 104 and a cover 106 at the bottom and top thereof, respectively. A wafer guide 108 to support a wafer is arranged inside the bath 102. A nozzle 110 for supplying nitrogen (N₂) or isopropyl alcohol to the bath 102 is arranged at one side of the bath 102. At that side of the bath 102, a first supply device 112 for supplying hydrofluoric acid (HF) and deionized water to the bath 102 is also provided. A first supply line 114 for supplying hydrofluoric acid (HF) and a second supply line 116 for supplying deionized water are connected to the first supply device 112. In addition, a second supply device 118 for supplying hydrogen peroxide (H₂O₂) is arranged on the other side of the bath 102.

A mixed solution 210 of the dilute hydrofluoric acid (HF) solution and hydrogen peroxide (H₂O₂) solution is supplied in a sufficient amount such that the wafer, which will be loaded to the bath 102 by subsequent wafer loading, is completely immersed in the mixed solution 210. The concentration of hydrofluoric acid (HF) and hydrogen peroxide (H₂O₂) contained in the mixed solution 210 are preferably 44 wt % to 53 wt % HF, highly preferably 49 wt % HF, and 25 wt % to 35 wt % H₂O₂, highly preferably 30 wt % H₂O₂. The volumetric ratio of hydrofluoric acid to deionized water to hydrogen peroxide (H₂O₂) contained in the mixed solution 210 is preferably in the range of 1 to 100-300 to 0.05-0.1, respectively. In addition, the temperature of the mixed solution 210 is preferably set to a range of about 20° C. to 30° C.

Referring to FIG. 2, a wafer 100 is loaded into the bath 102 filled with the mixed solution 210. The wafer 100 may be loaded to the bath 102 in the batch form of a set including a plurality of wafers. A metal-containing layer (not shown) of the wafer 100 is exposed. The metal-containing layer may include a metal layer or a metal oxide layer. For example, the metal layer may include a titanium (Ti) film, a copper (Cu) film, a platinum (Pt) film, or a ruthenium (Ru) film. The metal oxide layer may include an alumina (Al₂O₃) layer, a hafnium oxide (HfO₂) layer, a zirconium oxide (ZrO₂) layer, a tantalum oxide (Ta₂O₅) layer or a titanium dioxide (TiO₂) layer in addition to or in place of a metal layer.

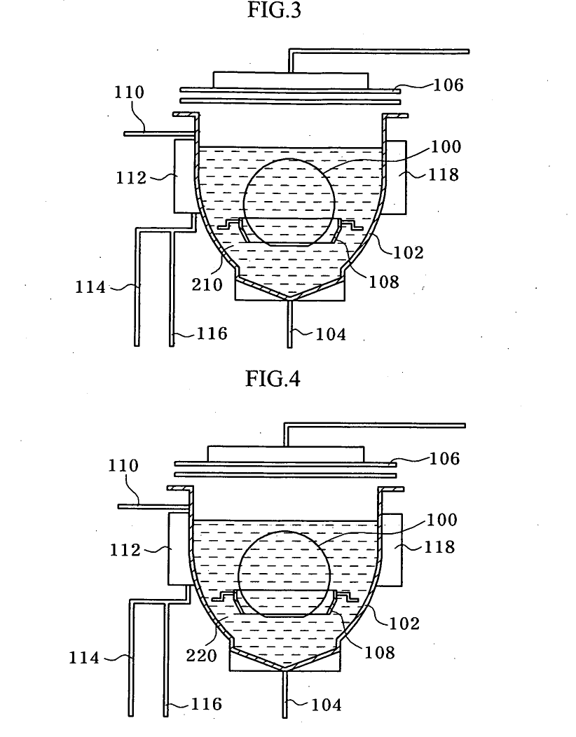

Referring to FIG. 3, the wafer 100 supported on a wafer support 108 such that the wafer 100 is completely immersed in the mixed solution 210. That state is maintained for a specific period sufficient that the wafer 100 is rinsed by the mixed solution 210. In this rinse step, remnants of oxide layers and metal or metal oxide layers remaining on the wafer 100, are removed. If necessary, the mixed solution 210 may further contain another cleaning solution such as, for example, a sulfuric acid peroxide mixture (SPM; H₂SO₄:H₂O₂:H₂O), a buffered oxide etchant (BOE: NH₄F:H₂O: surfactant) and Standard Clean-1(SC-1). Alternatively, after first cleaning using the above-mentioned cleaning solution, the mixed solution 210 may be employed alone to carry out a final rinse step.

Next, referring to FIG. 4, the mixed solution 210 is drained through a drain line 104 provided at the bottom of the bath 102. Then, deionized water 220 is supplied to the bath 102. The deionized water 220 is supplied to the bath 102 through the second supply line 116 and the first supply device 112. Similar to the mixed solution 210, the deionized water 220 is also allowed to be supplied in a sufficient amount such that the wafer 100, which is supported by the wafer support 108, is completely dipped into the deionized water 220. Then, that state is maintained for a predetermined time period sufficient that the wafer 100 is rinsed by the deionized water 220 in the bath 100.

Next, referring to FIG. 5, the deionized water 220 is drained through a drain line 104 provided at the bottom of the bath 102. After completing drainage of the deionized water 220, the first final rinse with the mixed solution 210 and the second final rinse with the deionized water 220 are finished.

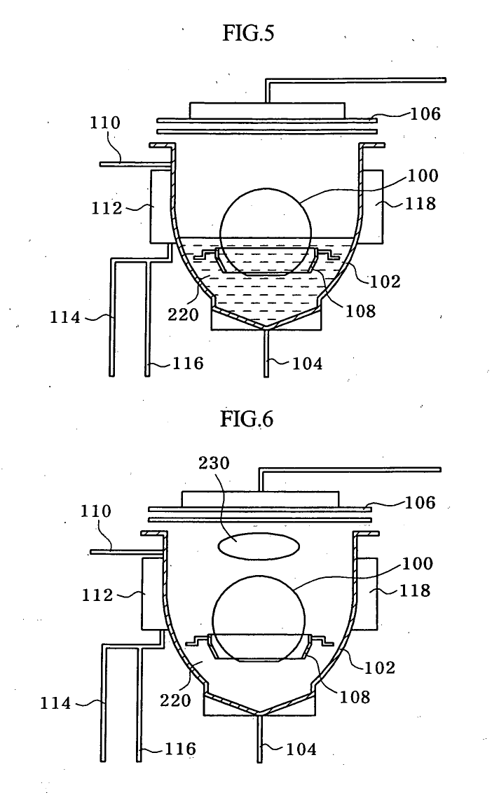

Then, referring to FIG. 6, isopropyl alcohol (IPA) vapor 230 is supplied to the bath 102 through the nozzle 110.

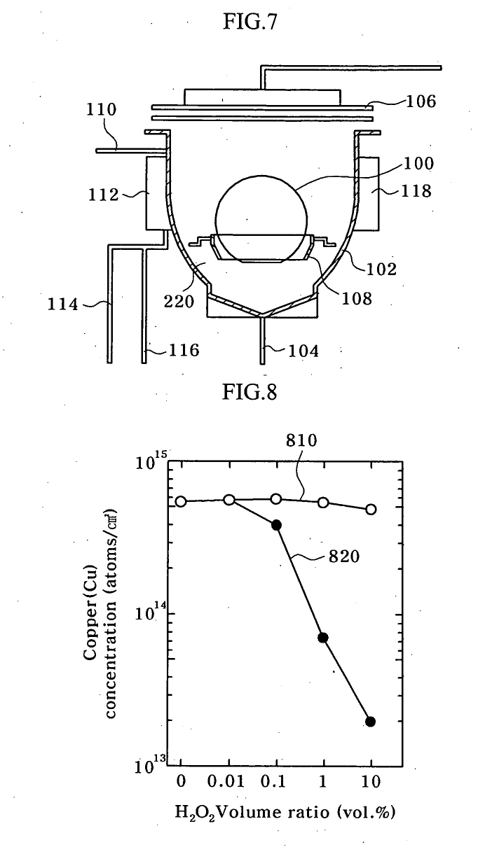

Next, referring to FIG. 7, a final drying step is carried out utilizing isopropyl alcohol vapor 230. That is, water present on the surface of the wafer 100 is removed by isopropyl alcohol vapor 230. Isopropyl alcohol is highly water-soluble and therefore water on the surface of the wafer 100 is quickly substituted with isopropyl alcohol, thereby being capable of drying the wafer 100 without causing water-marks on the surface of the wafer 100.

As described above, in accordance with the cleaning method of the invention, the final rinse with the mixed solution 210 containing dilute hydrofluoric acid (HF) and hydrogen peroxide (H₂O₂) can remove metal contaminants or residual substances present in the bath 102. Therefore, even after performing cleaning processes for the wafer 100 which contain material layers containing metals or metal oxide layers to be exposed outside, the same bath 102 can be used to carry out cleaning processes for other wafers without causing metal contamination.

As an example, upon performing etching for an upper electrode of the capacitor of the DRAM, an interlayer dielectric (ILD), alumina (Al₂O₃) as a dielectric layer and the upper electrode are sequentially etched, and thereby the side surface of alumina (Al₂O₃) is exposed in the course of such an etching process. Under such conditions, if cleaning processes are carried out using conventional SPM, BOE and SC-1 alone, this leads to contamination of the wafer with aluminum (Al) produced from the exposed surface of alumina (Al₂O₃). In contrast, as in the invention, where final rinsing is carried out using the mixed solution 210 consisting of dilute hydrofluoric acid (HF) and hydrogen peroxide (H₂O₂), contamination by aluminum (Al) is prevented. After this, even when wafers having passed through other process steps, for example wafers subjected to etching for formation of a landing plug contact connecting an impurity region of a semiconductor substrate to bit lines or a lower electrode of the capacitor, are cleaned in the same bath used in a previous rinse step, aluminum (Al) contamination does not occur. Similarly, this advantage can also be applied to cleaning processes performed before the deposition process.

FIG. 8 is a graph showing a degree of copper contamination with respect to content of hydrogen peroxide in a cleaning solution employed in a method of cleaning a semiconductor wafer in accordance with the invention.

With reference to FIG. 8, hydrogen peroxide (H₂O₂) was added to a hydrofluoric acid (HF) solution contaminated with 1 ppm copper (Cu), and the density of copper (Cu) with respect to the volume ratio of hydrogen peroxide (H₂O₂) added was measured. As can be seen from FIG. 8, addition of hydrogen peroxide (H₂O₂), as represented by reference numeral 820, caused a reduction in the concentration of copper (Cu), as compared to no addition of hydrogen peroxide (H₂O₂), as represented by reference numeral 810. In particular, as the volume ratio of hydrogen peroxide (H₂O₂) is increased, the concentration of copper (Cu) remarkably decreases.

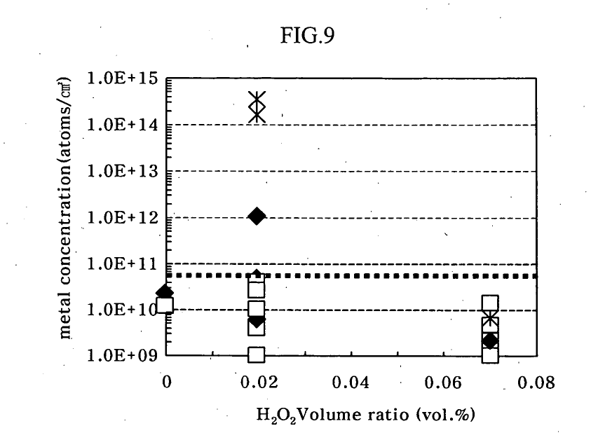

FIG. 9 is a graph showing a degree of metal contamination with respect to a volume ratio of hydrogen peroxide in a cleaning solution employed in a method of cleaning a semiconductor wafer in accordance with the invention.

Referring to FIG. 9, respective concentrations of various metals were determined with respect to a volume ratio of hydrogen peroxide (H₂O₂). As can be seen from FIG. 9, the concentration of aluminum (Al), as represented by the “♦” symbol, was determined to be acceptable (“dotted line”), i.e., less than 5×10¹⁰ atoms/cm², at a volume ratio of more than about 0.03. The concentration of iron (Fe), as represented by the “□” symbol, was also determined to be acceptable (“dotted line”), i.e., less than 5×10¹⁰ atoms/cm², at a volume ratio of more than about 0.03. In addition, the concentration of hafnium (Hf), as represented by “*”, was determined to be acceptable (“dotted line”), i.e., less than 5×10¹⁰ atoms/cm², at a volume ratio of more than about 0.03. As can be seen from these results, it is possible to maintain metal concentrations below acceptable levels, at a volume ratio of more than about 0.05 of hydrogen peroxide (H₂O₂). Therefore, addition of a volume ratio of more than about 0.05 of hydrogen peroxide (H₂O₂) is most effective for preventing metal contamination.

As apparent from the above description, the method of cleaning a semiconductor wafer in accordance with the invention performs the final rinse step utilizing the mixed solution of dilute hydrofluoric acid (HF) and hydrogen peroxide (H₂O₂), and thereby provides advantages such as no metal contamination of the wafer even upon performance of cleaning processes for wafers exposing metal contamination source, capability to inhibit yield reduction due to metal contamination even upon use of the same cleaning facility for various other processes, and prevention of deterioration in properties at interfaces between respective material layers, due to metal impurities.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A method of cleaning a semiconductor wafer, comprising the steps of:
supplying a mixed solution of a dilute hydrofluoric acid solution and a hydrogen peroxide solution to a bath;
loading a semiconductor wafer into the bath and dipping the semiconductor wafer into the mixed solution, rinsing the semiconductor wafer with the mixed solution;
draining the mixed solution and supplying deionized water to the bath, rinsing the semiconductor wafer with the deionized water; and
draining the deionized water and supplying isopropyl alcohol to the bath, drying the semiconductor wafer with the isopropyl alcohol.

2. The method of claim 1, comprising loading the semiconductor wafer to the bath in a batch form of a set comprising a plurality of wafers.

3. The method of claim 1, wherein concentration of hydrofluoric acid in the mixed solution is 44 wt % to 53 wt %.

4. The method of claim 1, wherein concentration of hydrofluoric acid in the mixed solution is 49 wt %.

5. The method of claim 1, wherein the concentration of hydrogen peroxide in the mixed solution is 25 wt % to 35 wt %.

6. The method of claim 1, wherein the concentration of hydrogen peroxide in the mixed solution is 30 wt %.

7. The method of claim 3, wherein the concentration of hydrogen peroxide in the mixed solution is 25 wt % to 35 wt %.

8. The method of claim 4, wherein the concentration of hydrogen peroxide in the mixed solution is 30 wt %.

9. The method of claim 1, wherein the volume ratio of hydrofluoric acid to deionized water to hydrogen peroxide contained in the mixed solution is in a range of 1 to 100-300 to 0.05-0.1.

10. The method of claim 1, wherein the temperature of the mixed solution is in a range of 20° C. to 30° C.

11. A method of cleaning a semiconductor wafer, comprising the steps of finally rinsing a semiconductor wafer having an exposed metal-containing layer with a mixed solution of a dilute hydrofluoric acid solution and a hydrogen peroxide solution.

12. The method of claim 11, wherein concentration of hydrofluoric acid in the mixed solution is 44 wt % to 53 wt %.

13. The method of claim 11, wherein concentration of hydrofluoric acid in the mixed solution is 49 wt %.

14. The method of claim 11, wherein the concentration of hydrogen peroxide in the mixed solution is 25 wt % to 35 wt %.

15. The method of claim 11, wherein the concentration of hydrogen peroxide in the mixed solution is 30 wt %.

16. The method of claim 12, wherein the concentration of hydrogen peroxide in the mixed solution is 25 wt % to 35 wt %.

17. The method of claim 13, wherein the concentration of hydrogen peroxide in the mixed solution is 30 wt %.

18. The method of claim 11, wherein the volume ratio of hydrofluoric acid to deionized water to hydrogen peroxide contained in the mixed solution is in a range of 1 to 100-300 to 0.05-0.1.

19. The method of claim 11, wherein the temperature of the mixed solution is in a range of 20° C. to 30° C.

20. The method of claim 11, further comprising the steps of rinsing the semiconductor wafer with deionized water after rinsing with said mixed solution.

21. The method of claim 20, further comprising drying the semiconductor wafer after rinsing with deionized water.

22. The method of claim 21, comprising drying the water with isopropyl alcohol.

23. The method of claim 6, wherein the metal-containing layer includes a metal layer or a metal oxide layer.

24. The method of claim 23, wherein the layer is a metal layer selected from the group consisting of titanium films, copper films, platinum films, and ruthenium films.

25. The method of claim 23, wherein the layer is a metal oxide layer selected from the group consisting of alumina layers, hafnium oxide layers, zirconium oxide layers, tantalum oxide layers, and titanium dioxide layers.
